(19) United States
(12) Patent Application Publication
(10) Pub. No.: US 2015/0037878 A1
(43) Pub. Date: Feb. 5, 2015

(54) PORTABLE SYSTEM FOR BREWING COMPOST TEA

(71) Applicant: John Musser, DeSoto, TX (US)

(72) Inventor: John Musser, DeSoto, TX (US)

(21) Appl. No.: 14/448,821

(22) Filed: Jul. 31, 2014

Related U.S. Application Data
(60) Provisional application No. 61/860,653, filed on Jul. 31, 2013.

(51) Int. Cl. C05F 17/02

(52) U.S. Cl. CPC C05F 17/027
USPC 435/290.1

(57) ABSTRACT

Embodiments disclosed herein disclose a system for brewing compost tea. The system includes a bucket that has an opening and a handle. A lid defining a plurality of holes and is configured to cover the opening in the bucket. An air pump is coupled to the lid. At least one air hose is coupled to the air pump and received through one of the holes. At least one air stone is coupled to the at least one air hose. The air pump is operable to cause air bubbles to be expelled from the at least one air stone to facilitate aeration of a compost tea mixture contained by the bucket.

### PRIORITY CLAIM

This application claims priority under 35 U.S.C. §119(e) to U.S. Provisional Application for Patent Ser. No. 61/860,653, filed on Jul. 31, 2013, and entitled Portable System for Brewing Compost Tea, which is hereby incorporated by reference.

### BACKGROUND

Liquid fertilizer, also referred to as compost tea, is brewed using fish and animal waste with microbe activator (food). The compost tea is applied to fertilize crops and gardens. Often the compost tea brewing systems brew large quantities of compost tea using substantially permanent compost tea brewing systems. Smaller compost tea brewing systems are available, but oftentimes their use can be cumbersome and/or their assembly may be time consuming.

### SUMMARY

Embodiments disclosed herein disclose a system for brewing compost tea. The system includes a bucket that has an opening and a handle. A lid defining a plurality of holes and is configured to cover the opening in the bucket. An air pump is coupled to the lid. At least one air hose is coupled to the air pump and received through one of the holes. At least one air stone is coupled to the at least one air hose. The air pump is operable to cause air bubbles to be expelled from the at least one air stone to facilitate aeration of a compost tea mixture contained by the bucket.

Technical advantages of the system include portable and durable compost tea brewing system that is easily manufactured with low cost components. The system is also self-contained and easily assembled.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

A more complete understanding of the invention may be obtained by reference to the following drawings:

FIG. 1 illustrates a partially disassembled compost tea brewer according to the teachings of the present disclosure; and

FIG. 2 is an assembled view with portions broken away of the compost tea brewer shown in FIG. 1.

### DETAILED DESCRIPTION OF THE DRAWINGS

Compost tea is a highly effective liquefied fertilizer. It is organic and rich in nutrients. Compost tea is particularly beneficial in the growth of plants, flowers, vegetables, trees, bushes and the like. Microbes multiplied by brewing the compost tea live and thrive once sprayed or otherwise applied to gardens and crops.

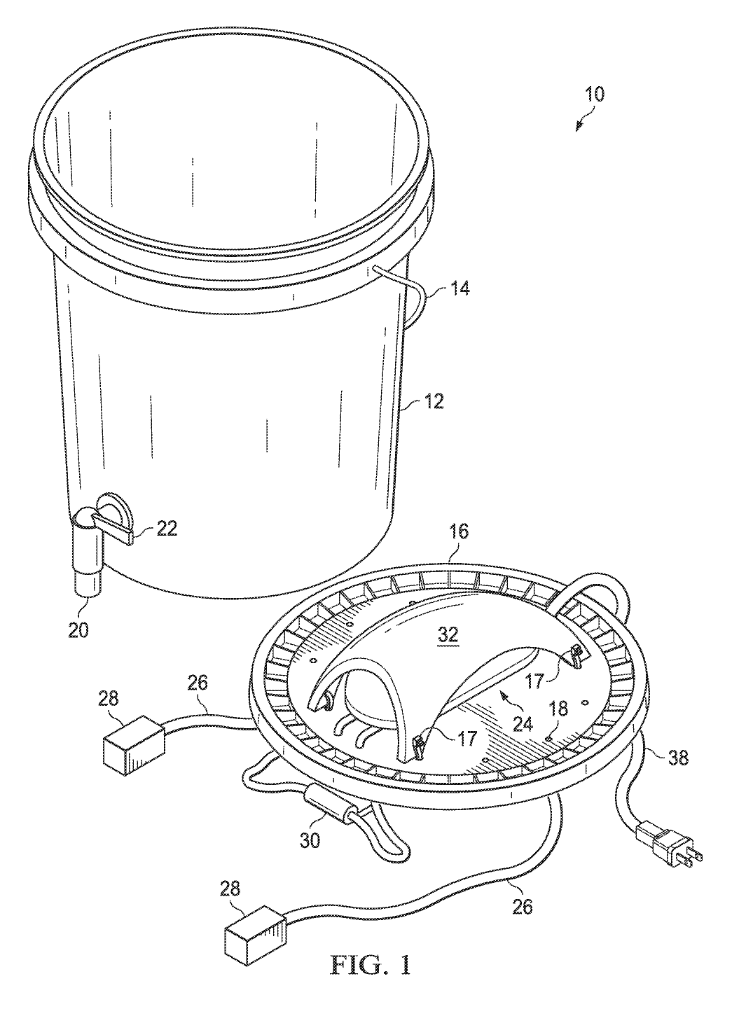

FIG. 1 illustrates a partially disassembled compost tea brewing system 10. The compost tea brewing system 10 is self-contained and includes a bucket 12 with a handle 14. The handle may be a wire bail-type handle with a plastic handgrip. The bucket 12 includes a lid 16. In the illustrated embodiment, the lid snaps on to the top of the bucket 12. The lid includes a plurality of holes 18 to allow the ambient air to reach the compost tea during brewing. The bucket 12 may be a conventional five-gallon bucket. The bucket 12 and/or the lid 16 may be made from any suitable polymeric material. For example, the bucket 12 and the lid 16 may be made from high density polyethylene.

A spout 20 is secured to a lower portion of the bucket 12. A hole is formed in a surface of the bucket 12, and the hole receives the spout. A seal ensures that the fluid connection between the spout 20 and the bucket is liquid tight to prevent leakage of the compost tea. The spout 20 is generally closed but a lever 22 on the spout is rotated to open the spout and allow the compost tea to flow from the bucket 12. In certain embodiments, the spout may include an internal filter to filter the compost tea as it is dispensed from the spout 20. In other embodiments, a nylon stocking (not shown) may be coupled to the spout 20. Upon opening the spout 20, the compost tea flows into the nylon stocking where it may be filtered such that the liquid that flows through the stocking and into another container is separated from the larger, typically solid, particles that remain in the nylon stocking. In certain embodiments, both a filter integrated into the spout 20 and a nylon stocking may be used to filter the compost tea.

An air pump 24 is coupled to the lid 16. Nylon ties 17 or any suitable coupling device may be used to secure the air pump to the top surface of the lid 16. One or more nylon ties 17 may be used to secure each of four corners of the pump 24 to the lid 16. At least one air hose 26 extends from the air pump 24 and through the lid 16. Air from the air pump 24 flows through the air hose 26 is expelled through one or more air stones 28 into the brewing compost tea to facilitate aeration of the mixture. In addition, a check valve 30 is disposed generally along the length of air hose 26 between the air pump and the air stones 28. The check valve 30 allows flow, specifically air flow, in only one direction and prevents backflow of liquid, such as compost tea, from reaching the air pump 24 where it can cause damage and/or ruin the air pump 24.

The air pump 24 may be any suitable air pump. In the embodiment shown in FIG. 1, the air pump 24 includes a contoured member defining a contoured top surface 32 in a dome shape. The dome shape may facilitate quiet operation of the air pump 24. In addition, the dome shape of the contoured member of the pump 24 allows the pump to be easily grasped to facilitate removal of the lid 16. In certain embodiments, the air pump 24 may be a Whisper® Aquarium Air Pump available under the trade name Tetra from the United Pet Group of Blacksburg, Va. A Tetra Whisper® Aquarium Air Pump sized to aerate up to a ten gallon aquarium tank is sized to fit on the top surface of the lid 16 and provides sufficient pumping power to aerate the compost tea. The compost tea mixture is fully oxygenated because the air pump 24 is rated for up to 10 gallons, but the bucket 12 is only five gallons.

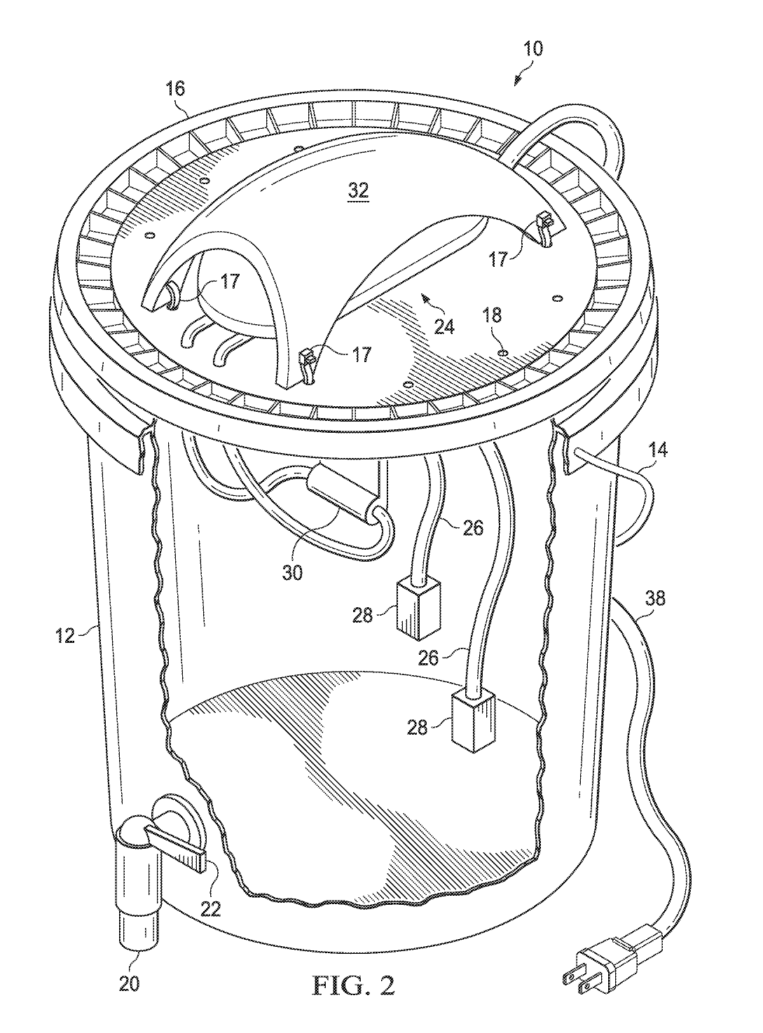

The air stones 28 provide small air bubbles, which are particularly beneficial in aerating the compost tea during brewing. The small bubbles from the air stones 28 accelerate microbial growth in the compost tea. In certain embodiments, two air hoses 26 are coupled to the air pump 24. As shown in FIG. 2, one air hose is long enough to reach the bottom of the bucket such that it hangs deeper in the compost tea mixture to allow the air stone 28 to expel air bubbles and create turbulence in that portion of the mixture. The other air hose 26 is shorter such that the air stone 28 coupled to it hangs shallower in the compost tea mixture to expel bubbles and create turbulence in that portion of the compost tea mixture. Thus, multiple depths of the compost tea mixture can be infused with air bubbles for the entire brewing process. The air stone 28 disposed at the more shallow depth ensures that the surface and just below the surface of the compost tea mixture receives turbulence and does not turn anaerobic. By simultaneously oxygenating the shallow and the deeper depths of the compost tea mixture, the resulting compost tea may have an earthy smell similar to the aroma of actual amber tea brewed from tea leaves.

The handle 14 allows the compost tea brewing system 10 to be portable. The system 10 including the air pump 24 may be easily carried by hand when it is empty or when it is filled with compost tea. In addition, the system 10 may also be carried while brewing.

The following is a method for brewing compost tea using the compost tea brewing system 10. The method starts with filling the bucket 12 approximately three-quarters full with non-chlorinated water. Alternatively, water from a fish tank may be used. However, when such water is used, the bucket 12 should only be half filled with the water including fish waste. Compost and a separate activator are introduced into the water in the bucket 12. The compost is a blend of small animal waste, cow manure, and fish emulsion. The activator supplies food to the microbes and may be organic. The activator and air create an environment for explosive microbial growth when added to the compost.

The water, compost, and activator, are stirred together in the bucket 12. After stirring the mixture, the lid 16 is placed onto the bucket 12. The air hose 26 and the air stones 28 hang below the lid 16 and into the mixture. The length of the air hose 26 is sufficient to allow the lid 16 to be removed from the bucket 16 slightly to facilitate monitoring the brewing process without drawing the air stones 28 out of the mixture. Thus, the brewing process may be periodically monitored cleanly and efficiently.

The air pump 24 is activated to supply air through the air stones 28 and into the mixture to brew the compost tea. In the illustrated embodiment, the air pump includes a power cord 38 that can be plugged into a wall outlet. However, in other embodiments, the air pump 24 may be battery powered.

Air is pumped into the compost tea mixture for approximately 48 hours, and the brewing process may be periodically monitored cleanly and efficiently, as described above. The air bubbles expelled from the air stones 28 facilitate aeration of the compost tea mixture and facilitate the growth of microbes that enhance the fertilizing function of the compost tea.

The compost tea may be dispensed from the bucket 12 into a spray bottle or other suitable container by opening the spout 20. As described above, the compost tea may be filtered through a nylon stocking before being received in the spray bottle. The spray bottle may be half filled with compost tea and then the rest may be filled with non-chlorinated water. The compost tea and water mixture may be sprayed onto plants as liquid fertilizer.

After all of the brewed compost tea is used as fertilizer, the compost tea brewing system 10 may be easily cleaned to prepare it for storage and/or subsequent brewing. If any compost tea was not dispensed by the spout 20, it may be easily dumped from the bucket 12. The bucket 12 may then be rinsed out, filled with clean water, and the pump 24 may be activated. After running the pump for 5-20 minutes, the water is emptied from the bucket 12 and the lid 16 is placed on the top of the bucket 12. The air hoses 26 and the air stones 28 hang neatly from the lid into the empty bucket 12 where they can dry to prevent growth of mold. The entire compost tea brewing system 10 is self-contained and conveniently stored in the space sized to accommodate the bucket 12.

Although preferred embodiments of the method and apparatus of the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A portable system for brewing compost tea, comprising:
a bucket having an opening and a handle;
a lid configured to cover the opening in the bucket, the lid defining a plurality of holes therethrough;
an air pump coupled to the lid;
at least one air hose coupled to the air pump and received through one of the holes;
at least one air stone coupled to the at least one air hose; and
wherein the air pump is operable to cause air bubbles to be expelled from the at least one air stone to facilitate aeration of a compost tea mixture contained by the bucket.

2. The system of claim 1, further comprising a spout coupled to a lower portion of the bucket.

3. The system of claim 1, further comprising at least one check valve disposed between the air pump and the at least one air stone.

4. The system of claim 1 wherein a top surface of the air pump is contoured.

5. The system of claim 4 wherein the top surface of the air pump is dome-shaped.

6. The system of claim 1 wherein the air pump includes a power cord configured to be received by a wall outlet.

7. The system of claim 1 wherein the bucket has a volume of approximately five gallons.

8. The system of claim 7 wherein the bucket and the lid are each formed from high density polyethylene.

9. The system of claim 1 wherein the at least one air hose is a plurality of air hoses and the at least one air stone is a plurality of air stones.

10. A portable liquid fertilizer brewer, comprising:
a bucket having an opening and a handle;
a lid configured to cover the opening in the bucket, the lid defining a plurality of air holes therethrough;
an air pump coupled to the lid;
a first air stone fluidly coupled to the air pump and disposed at a first depth within the bucket;
a second air stone fluidly coupled to the air pump and disposed at a second depth within the bucket, the second depth being deeper than the first depth; and
wherein the air pump is operable to cause air bubbles to be expelled from the first and second air stones to facilitate aeration of a liquid fertilizer mixture contained in the bucket.

11. The brewer of claim 10, further comprising a spout coupled to a lower portion of the bucket.

12. The brewer of claim 10, further comprising at least one check valve disposed between the air pump and the first and second air stones.

13. The brewer of claim 10 wherein a top surface of the air pump is contoured.

14. The brewer of claim 10 wherein the air pump includes a power cord configured to be received by a wall outlet.

15. The brewer of claim 10 wherein the bucket has a volume of approximately five gallons.

16. The brewer of claim 10 wherein the bucket and the lid are each formed from high density polyethylene.

17. The brewer of claim 10 wherein the first air stone disposed at the first depth is disposed to facilitate aeration of the liquid fertilizer mixture proximate a surface of the liquid fertilizer mixture.

18. The brewer of claim 17 wherein the first air stone disposed at the first depth is disposed to facilitate aeration of the liquid fertilizer mixture directly below the surface of the liquid fertilizer mixture.
